(19) United States
(12) Patent Application Publication
(10) Pub. No.: US 2007/0248855 A1
(43) Pub. Date: Oct. 25, 2007

(54) Fuel-Cell Stack Comprising a Tensioning Device

(75) Inventor: Andreas Reinert, Delbrueck (DE)

Correspondence Address: ROBERTS, MLOTKOWSKI & HOBBES, P. O. BOX 10064, MCLEAN, VA, 22102-8064, US

(73) Assignee: STAXERA GMBH, Dresden (DE)

(21) Appl. No.: 11/573,144

(22) PCT Filed: Jul. 20, 2005
(86) PCT No.: PCT/DE05/01286

§ 371 Date: Feb. 2, 2007

(30) Foreign Application Priority Data
Aug. 2, 2004 (DE) 10 2004 037 678.6

(51) Int. Cl. H01M 8/12; H01M 8/02

(52) U.S. Cl. 429/19; 429/12; 429/30

(57) ABSTRACT

A fuel cell stack (10) with fuel cells (12), a clamping device (16) and a heat insulating device (14), the clamping device (16) having pressure distribution elements (18) and the fuel cells (12) being located between the pressure distribution elements (18). The fuel cell stack (10) is characterized by the fact that the heat insulating device (14) is located between the fuel cells (12) and the clamping device (16).

### BACKGROUND OF THE INVENTION

1. Field of the Invention

The invention relates to a fuel cell stack with fuel cells, a clamping device and a heat insulating device, the clamping device having pressure distribution elements and the fuel cells being located between the pressure distribution elements.

2. Description of Related Art

Fuel cells have an ion-conducting electrolyte with which contact is made on both sides via two electrodes, anode and cathode. The anode is supplied with a reducing, generally hydrogen-containing fuel, and an oxidizer, for example, air, is supplied to the cathode. The electrons released in the oxidation of the hydrogen contained in the fuel on the electrode are routed to the other electrode via an external load circuit. The chemical energy being released is thus available to the load circuit with high efficiency directly as electrical energy.

To achieve higher outputs, several planar fuel cells are often layered on top of one another in the form of a fuel cell stack and are electrically connected in series. This fuel cell stack is held together by forces of pressure, the forces of pressure being applied by a clamping device. The clamping device comprises pressure distribution elements which are connected to one another in a suitable manner and by which the compression forces produced by the clamping device are applied uniformly to the fuel cell stack. The stacked fuel cells and the clamping device are then surrounded by a heat insulating device to reduce heat losses to the outside.

Fuel cells are, for example, made as low temperature fuel cells, such as, for example, a PEMFC (polymer electrolyte membrane fuel cell) with operating temperatures of roughly 100° C. This has the advantage that suitable materials for the clamping device in this temperature range are available. Moreover, there are high temperature fuel cells, especially a solid oxide fuel cell (SOFC) which is operated at temperatures above 800° C. In this temperature range, many materials have no permanently elastic action since the applied prestressing forces are consumed by creep processes. Moreover, the materials used for the clamping device generally have a larger coefficient of thermal expansion than the stack of fuel cells. Moreover recrystallization effects occur in the metals used for the clamping device, by which they become soft.

### SUMMARY OF THE INVENTION

To avoid these problems, it is provided in accordance with the invention that a heat insulating device is located between the fuel cells and the clamping device.

The basic idea of the invention is that, in this arrangement, all tension-loaded elements of the clamping device and all elastic elements are located in a cold region outside of the heat insulation.

Advantageously, the clamping device has tension elements which are made of rod, cable, wire, chain, belt or fiber material. Thus, much less material can be used for the tension elements than is conventional in the prior art. It is especially favorable if the tension elements are made of a lightweight metal, such as, for example, aluminum. This leads both to cost savings and also to a reduction of the volume and weight of the fuel cell stack.

Furthermore, in accordance with the invention, the fuel cell system is provided with an energy-producing unit, the energy-producing unit comprising a reformer, a fuel cell stack with fuel cells and an afterburning unit, the fuel cell system also having a clamping device with pressure distribution elements and a heat insulating device, and the energy-producing unit being located between the pressure distribution elements, the heat insulating device being located between the energy-producing unit and the clamping device. In this arrangement of an energy-producing unit, all tension-loaded elements of the clamping device and all elastic elements are located in the cold region outside of the heat insulation.

The invention is explained in detail below with reference to the accompanying drawings.

### BRIEF DESCRIPTION OF THE DRAWINGS

FIG. 1 is a cross section through a fuel cell stack in accordance with the invention in a first embodiment,

FIG. 2 is a cross section through a fuel cell stack of a second embodiment of the invention,

FIG. 3 is a cross section through a fuel cell stack of a third embodiment of the invention,

FIGS. 4a & 4b are cross sections through a fuel cell stack of a fourth embodiment of the invention, FIG. 4a showing a cross section through the fuel cell stack along line IV A-IV A in FIG. 4b,

FIGS. 5a & 5b are cross sections through a fuel cell stack of a fifth embodiment of the invention, FIG. 5a showing a cross section through the fuel cell stack along line V A-V A, of FIG. 5b and

FIG. 6 is a cross section through a fuel cell system in accordance with the invention with an energy-producing unit.

### DETAILED DESCRIPTION OF THE INVENTION

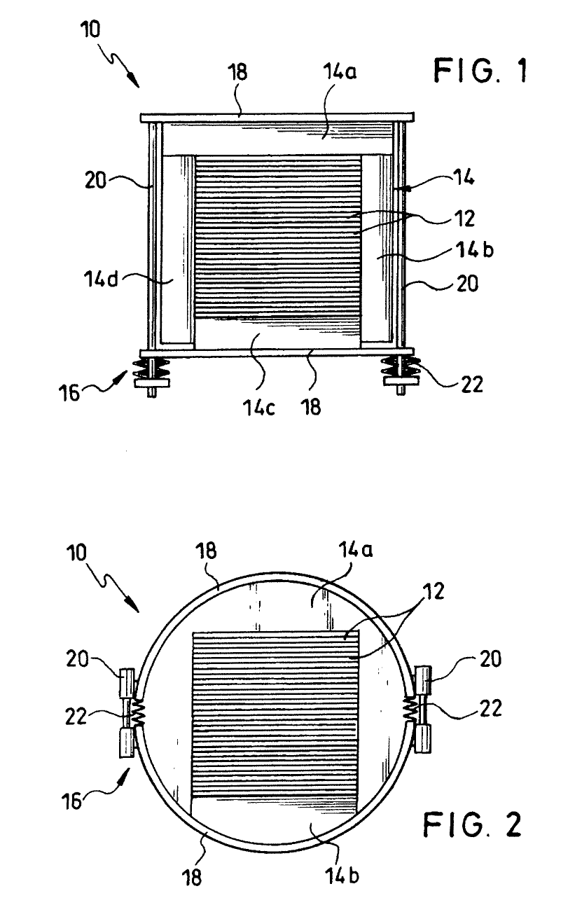

FIG. 1 shows a fuel cell stack 10. In the center of the fuel cell stack 10 are the stacked fuel cells 12 which are surrounded by a heat insulating device 14 comprised of several heat insulating elements 14a, 14b, 14c, 14d. The fuel cells 12 and heat insulating device 14 are clamped together in a clamping device 16. The clamping device has two pressure distribution elements 18 which are made here as two parallel flat plates and which are connected to one another by tension elements 20. A pressure force is applied to the combination of fuel cells 12 and heat insulating device 14 by this version of the clamping device 16. The pressure distribution elements 18 provide for the pressure being distributed uniformly on the entire surface of the heat insulating elements 14a, 14c, by which also the distribution of compressive forces on the fuel cells 12 takes place. The clamping device 16 also has spring elements 22 by which the compressive load on the combination of fuel cells 12 and heat insulating device 14 can be very precisely adjusted. Moreover, re-adjustment can take place if expansions or contractions occur, for example, by sintering of the heat insulating device 14.

The tension elements 20 can be made here as a bar, cable, wire, chain, belt or fiber material, so that much less material need be used as compared to the prior art, and thus, a lighter and more space-saving construction can be achieved. It is especially preferred if the tension elements 20 are made of a lightweight metal, for example, aluminum. The weight of the fuel cell stack 10 is thus clearly reduced.

The spring elements 22 can be made as helical springs, disk springs, leg springs, cable-pull springs or pneumatic springs, and especially elastomers can be used as the material. Since both the tension elements 20 and also the spring elements 22 are outside of the heat insulating device 14, they are only exposed to lower temperatures. For these elements 20, 22, thus, less temperature-resistant and also more economical materials can be used than in prior art devices, where these elements are located within the heat insulating device 14, and thus, are exposed to much higher temperatures. Moreover, the outside arrangement of the clamping device 16 results in that the heat losses of the fuel cell stack 10 are altogether much less since no parts of the clamping device 16 are routed out of the hot region into the cold region.

The heat insulating elements 14a to 14d of the heat insulating device 14 can be made in one especially preferred embodiment either as a monolayer of microporous insulating materials, sandwich structure or of a composite material. These heat insulating elements have an especially pressure-resistant structure so that the pressures built up by the clamping device 16 can be captured especially well.

In the fuel cell stack 10 shown in FIG. 2, the heat insulating device 14 is made cylindrical or spherical. Accordingly, the pressure distribution elements 18 can be made hemispherical or semicylindrical. There are the spring elements 22 between the pressure distribution elements 18. A connection between the two pressure distribution elements 18 is achieved here by tension elements 20 which are located in the transition region between the two pressure distribution elements 18 near the spring elements 22. Similar to the embodiment from FIG. 1, the tension elements 20 apply a tension force to the two pressure distribution elements 18. In this embodiment, an especially favorable pressure distribution is achieved via the hemispherical or semi-cylindrical shell of the pressure distribution element 18.

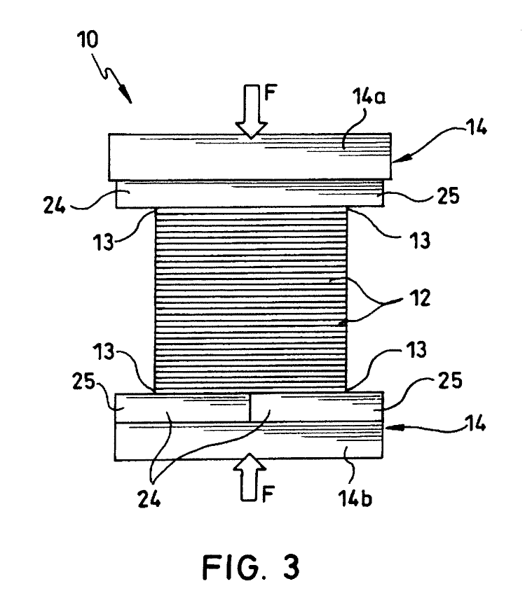

The heat insulating device 14 of the fuel cell stack 10 shown in FIG. 3 has three porous layer elements 24 which are directly adjacent to the fuel cells 12. The porous layer elements 24 are at least partially surrounded by sheet elements 25 which preferably are made of metal. If the fuel cell stack 10 is exposed to a force from overhead (symbolized here by the arrows F), the layer elements 24 surrounded by the sheet metal elements 25 remain stable in shape and the heat insulating elements 14a, 14b are prevented by the layer elements 24 from flowing up and down over the edges 13 of the fuel cells 12; this would lead to destruction of the heat insulating device 14 or the fuel cells 12. Due to the layer elements 24 surrounded by the sheet metal elements 25, the entire heat insulating device 14 also remains stable in shape even when exposed to a force F.

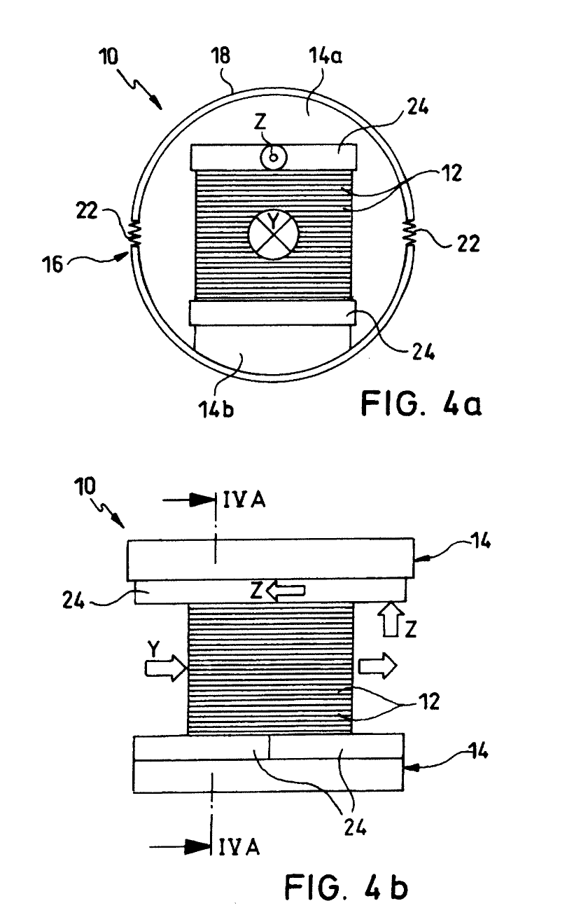

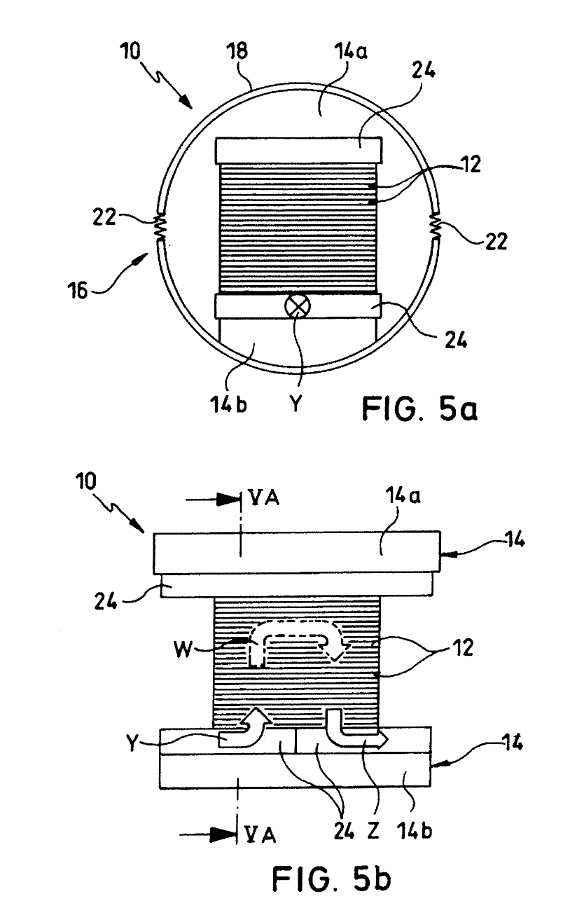

The embodiments of the fuel cell stack 10 shown in FIGS. 4a, 4b, 5a and 5b correspond in their basic structure to the one from FIG. 3, but here a gaseous operating medium is routed through at least one porous layer element 24 at a time. FIGS. 4a & 5a each show cross sections through the fuel cell stack 10 of FIGS. 4b & 5b in the direction of the lines IV A-IV A and V A-V A, respectively, with the clamping device 16 and the pressure distribution elements 18 as well as the spring elements 22.

In the embodiment of FIGS. 4a & 4b, gaseous operating medium is conveyed in the direction of the arrow Y (FIG. 4b, left) through the fuel cells 12 to emerge on the opposing side (FIG. 4b, right) and to be returned in the direction of the arrows Z through the upper layer element 24 of the porous, load-bearing metal foam, and finally, on the left side (FIG. 4b) to emerge again from the layer element 24. Parts of the gas guide in the fuel cell stack 10 can be saved by making the porous layer element 24 as a gas-carrying element.

In the embodiment of FIGS. 5a & 5b, the gaseous operating medium is conveyed in the direction of the arrow Y (FIG. 5b, left) through the left bottom layer element 24 of porous, load-bearing metal foam and via a distributor system (not shown) to the fuel cells 12. The operating medium then travels through the fuel cells 12 (in FIG. 5b in the plane of the drawing to right rear, symbolized by the arrow W) to emerge on the side of the fuel cells 12 which is the back side in FIG. 5b and to emerge on the right side (FIG. 5b) of the fuel cell stack 10 via a collector system (not shown) and the right rear layer element 24 of porous, load-bearing metal foam in the direction of arrow Z. Here, parts of the gas guide in the fuel cell stack 10 can also be saved by making the two porous layer elements 24 as gas-carrying elements.

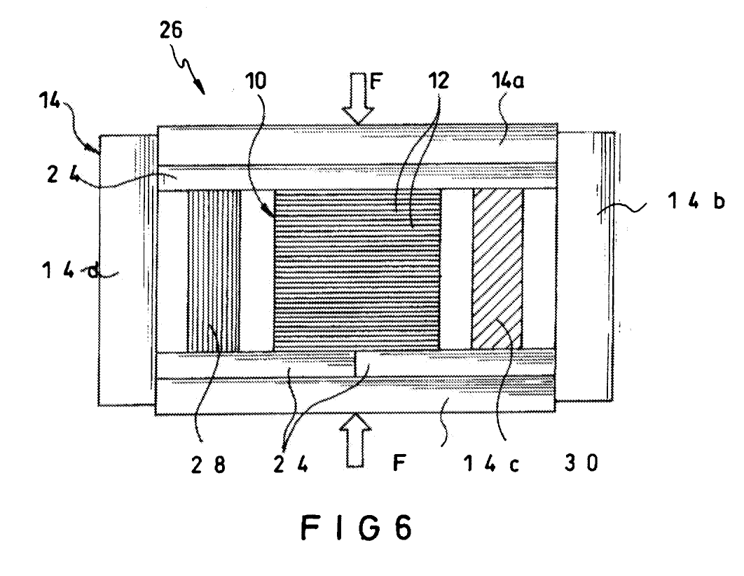

Finally, FIG. 6 shows a fuel cell system 26 with an energy-producing unit which is comprised of a reformer 28, the fuel cell stack 10 with fuel cells 12 and an afterburning unit 30 as the central components. The components 28, 10, 30 of the fuel cell system 26 are surrounded by a heat insulating device 14 consisting of heat insulating elements 14a-d and porous layer elements 24. The clamping device (not shown here) is located outside the heat insulating device 14 and applies tension forces F to the fuel cell system 26, holding it together. The structure of the fuel cell system 26 is otherwise analogous to the structure of the embodiments of the fuel cell stack 10 which are shown in FIGS. 3 to 5. Of course, all the features shown for the fuel cell stack 10 can also be applied to the fuel cell system 26.

The described embodiments of the fuel cell stack 10 and of the fuel cell system 26 are especially suited for use with solid oxide fuel cells which are operated at temperatures from 800 to 900° C. In particular, in such a high temperature system, the described materials and components exhibit their advantages with respect to volume and weight reduction, and thus, cost reduction.

A process will be described below which allows especially simple changing of the fuel cells 12 and the heat insulating device 14.

In a first step, the spring elements 22 must be loosened. Then, the pressure distribution elements 18 can be separated from the tension elements 20. It is now possible, either by removing the heat insulating device 14 from the fuel cell stack 10 or from the fuel cell system 26, to replace the fuel cells 12 (and optionally, the reformer 28 and the afterburning unit 30) alone or in combination together with the heat insulating device 14. After replacement, the pressure distribution elements 18 are connected to the tension elements 20. Then, by attaching the spring elements 22, the entire fuel cell stack 10 and fuel cell system 26 are joined together under tension.

1-18. (canceled)

19. Fuel cell stack with fuel cells, a clamping device and a heat insulating device, the clamping device having pressure distribution elements and the fuel cells being located between the pressure distribution elements, wherein the heat insulating device is located between the fuel cells and the clamping device.

20. Fuel cell stack as claimed in claim 19, wherein the clamping device has tension elements form of one of a rod, cable, wire, chain, belt, and fiber material.

21. Fuel cell stack as claimed in claim 20, wherein the tension elements are made of lightweight metal.

22. Fuel cell stack as claimed in claim 21, wherein said lightweight metal is aluminum.

23. Fuel cell stack as claimed in claim 19, wherein the clamping device has spring elements in the form of one of helical springs, disk springs, leg springs, cable-pull springs, and pneumatic springs.

24. Fuel cell stack as claimed in claim 23, wherein the spring elements are made of an elastomeric material.

25. Fuel cell stack as claimed in claim 19, wherein the spring elements are located between the pressure distribution elements.

26. Fuel cell stack as claimed in claim 19, wherein the heat insulating device comprises a sandwich structure.

27. Fuel cell stack as claimed in claim 19, wherein the heat insulating device is made of a composite material.

28. Fuel cell stack as claimed in claim 19, wherein the heat insulating device comprises at least one porous layer element

29. Fuel cell stack as claimed in claim 28, wherein the porous layer element is comprised of a metal foam.

30. Fuel cell stack as claimed in claim 28, wherein the porous layer element is at least partially surrounded by a sheet metal element.

31. Fuel cell stack as claimed in claim 28, wherein a gaseous operating medium is routed through the porous layer element.

32. Fuel cell stack as claimed in claim 19, wherein the pressure distribution elements are essentially flat plates which are parallel to one another.

33. Fuel cell stack as claimed in claim 19, wherein the pressure distribution elements are in the form of a hemispherical shell.

34. Fuel cell stack as claimed in claim 19, wherein the pressure distribution elements are semi-cylindrical.

35. Fuel cell stack as claimed in claim 19, wherein the fuel cells are solid oxide fuel cells.

36. Fuel cell system with an energy-producing unit, the energy-producing unit comprising a reformer, a fuel cell stack with fuel cells and an afterburning unit, the fuel cell system also having a clamping device with pressure distribution elements and a heat insulating device, wherein the energy-producing unit is located between the pressure distribution elements, and wherein the heat insulating device is located between the energy-producing unit and the clamping device.
